(19) United States
(12) Patent Application Publication
(10) Pub. No.: US 2004/0117495 A1
(43) Pub. Date: Jun. 17, 2004

(54) Associating time information with data received at a digital signal processor based physical layer processing unit

(76) Inventors: Eliel Louzoun, Jerusalem (IL); Jacob Twersky, Maale-Adumim (IL); Yifat Ben-Shahar, Mevascret Zion (IL); Meir Tsadik, Hod Hasharon (IL)

Correspondence Address: BUCKLEY, MASCHOFF, TALWALKAR LLC, 5 ELM STREET, NEW CANAAN, CT, 06840, US

(21) Appl. No.: 10/321,057

(22) Filed: Dec. 17, 2002

(51) Int. Cl. G06F 15/16

(52) U.S. Cl. 709/230

(57) ABSTRACT

According to some embodiments, time information is associated with data received at a digital signal processor based physical layer processing unit.

### BACKGROUND

A network device may facilitate an exchange of information via a network. For example, a physical layer processing unit (PHY) in a network device may receive analog signals from the network (e.g., from a wire) and convert the signals into digital information. The network device may then process the digital information in accordance with a network protocol. The network protocol may, for example, require that information be processed based on when an event occurred in the network. In other words, the network device may need to process information based on when the information was received at the PHY (e.g., collision processing). Similarly, the network device may generate information that should be transmitted from the PHY to the network at a particular time.

It is known that a dedicated hardware machine can be designed to receive, process, and transmit information in accordance with a network protocol. Such a machine, however, may need to be re-designed when a change is made to the network protocol. Moreover, it can be difficult to design a single dedicated hardware machine that is able process information in accordance with a number of different network protocols.

To overcome these problems, a network device may use a programmable Digital Signal Processor (DSP) to process information in accordance with one or more network protocols. In this case, the time that information is received by the PHY will be different than the time that the information is processed by the DSP. Moreover, the difference between these times may vary (e.g., because the processing is being performed by firmware instead of a dedicated hardware machine). Similarly, the DSP may be unable to control exactly when information is transmitted to the network. As a result, it may be difficult to efficiently process information in accordance with the network protocol.

### BRIEF DESCRIPTION OF THE DRAWINGS

FIG. 1 is a block diagram of a digital signal processor according to some embodiments.

FIG. 2 is a flow chart of a method according to some embodiments.

FIG. 3 is a block diagram of a physical layer processing unit in a network device according to some embodiments.

FIG. 4 is a flow chart of a method of receiving data according to some embodiments.

FIG. 5 illustrates a receive data first-in, first-out memory structure according to some embodiments.

FIG. 6 is a flow chart of a method of processing data according to some embodiments.

FIG. 7 is a flow chart of a method of transmitting data according to some embodiments.

FIG. 8 is a system according to some embodiments.

### DETAILED DESCRIPTION

Some embodiments described herein are associated with a “network device.” As used herein, the phrase “network device” may refer to any device that receives, process, and/or transmits information in accordance with a network protocol. By way of example, a network device may comprise a network processor, a switch, a router, or a modem.

Moreover, the network may comprise a home network, a power line network, a phone line network, a Local Area Network (LAN), a Metropolitan Area Network (MAN), a Wide Area Network (WAN), a Fast Ethernet network, a wireless network, a fiber network, and/or an Internet Protocol (IP) network, such as the Internet, an intranet, or an extranet. In addition, information may be processed in accordance with, for example, the Fast Ethernet Local Area Network (LAN) transmission standard 802.3-2002® published by the Institute of Electrical and Electronics Engineers (IEEE).

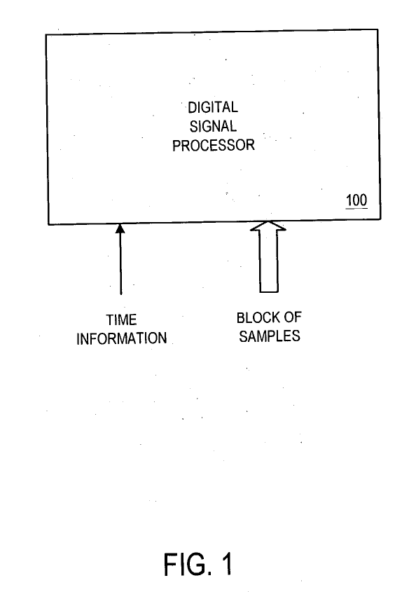

FIG. 1 is a block diagram of a DSP 100 according to some embodiments. The DSP 100 may, for example, be incorporated in a network device. According to some embodiments, the DSP 100 can be configured to process information in accordance with any one of a number of different network protocols. Similarly, the DSP 100 might be able to process information in accordance with a programmable network protocol (e.g., the DSP 100 may be re-programmed when a change is made to the network protocol). As can be seen in FIG. 1, the DSP 100 may receive a block of samples and associated time information.

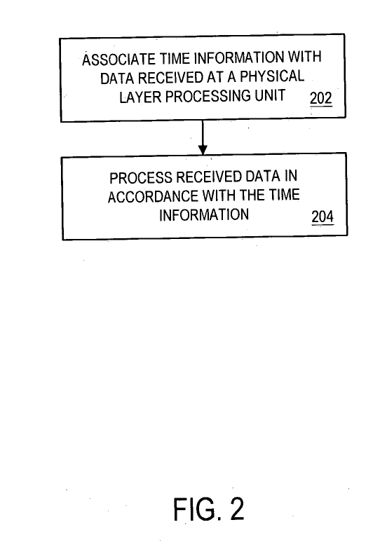

Refer now to FIG. 2, which is a flow chart of a method according to some embodiments. The flow charts described herein do not imply a fixed order to the actions, and embodiments may be practiced in any order that is practicable. The method may be associated with, for example, a network device that includes the DSP 100.

At 202, time information is associated with data received at a PHY. For example, the PHY may receive data from a network via an Analog-to-Digital (A/D) converter. According to some embodiments, the received data comprises a block of samples that are stored in a receive data memory structure at the PHY.

The time information may be associated with, for example, a time when one or more of the samples was received (or stored) by the PHY. For example, the time information may comprise a time stamp that is stored in a time register.

At 204, the received data is processed in accordance with the time information. For example, the block of samples may be transferred from the receive data memory structure at the PHY to a memory unit associated with the DSP 100 (e.g., a main memory). The DSP 100 may then process each sample in accordance with a network protocol and the information in the time register (e.g., to perform carrier sense or collision processing). According to some embodiments, the DSP 100 also calculates' a time associated with a particular sample based on the information in the time register and the position of that particular sample in the block.

The DSP 100 processes the received data, extracts events and timing information, and passes the information to a Media Access Control layer (MAC). The events and timing information may be used by the MAC to implement MAC layer protocol. According to some embodiments, the DSP 100 also uses timing information to schedule when data will be transmitted to the network.

Physical Layer Processing Unit

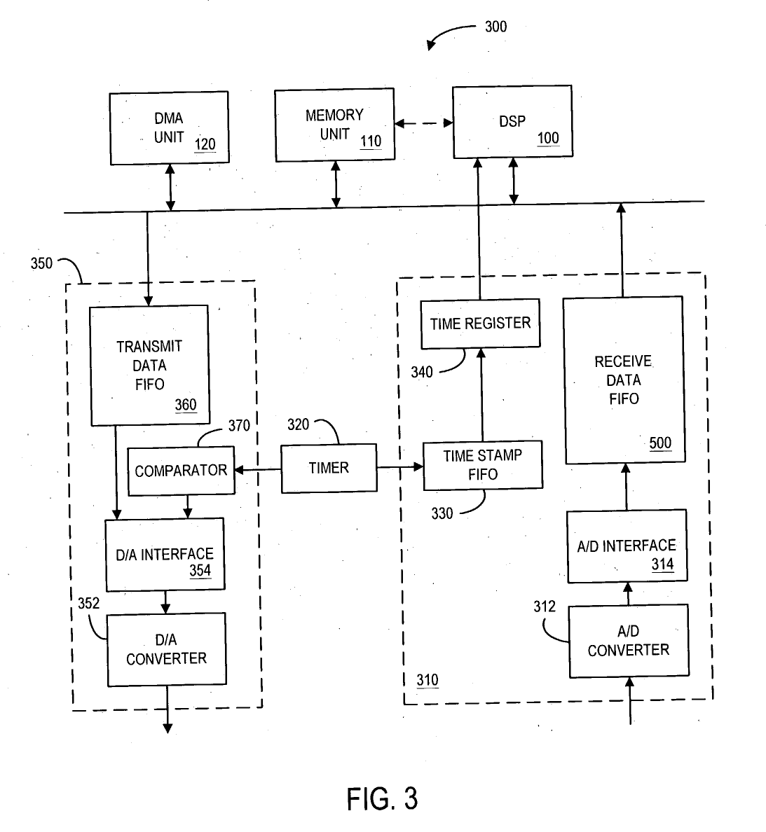

FIG. 3 is a block diagram of a PHY 300 in a network device according to some embodiments. The PHY 300 includes the DSP 100 and an associated memory unit 110 (e.g., a main memory).

The PHY 300 also includes an input module 310 to receive information from a network (e.g., from a wire) and an output module 350 to transmit information to the network (e.g., to a wire). A Direct Memory Access (DMA) unit 120 may facilitate a transfer of information from the input module 310 to the memory unit 110 and/or from the memory unit 110 to the output module 350. Note that the DSP 100 may, according to some embodiments, exchange information directly with the memory unit 110.

The PHY 300 also includes a timer 320. The timer 320 may be, for example, a free-running counter that runs at a sampling rate associated with the PHY 300. For example, the timer 320 may be able to generate unique time indications (e.g., time stamps) for several seconds.

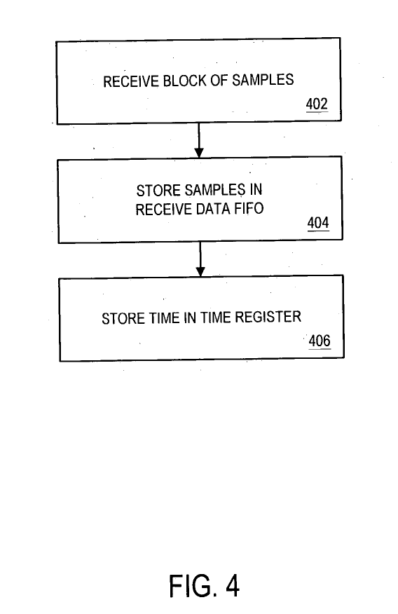

The operation of the PHY 300 according to some embodiments will now be described with respect to FIGS. 4 through 6.

Receiving Data

FIG. 4 is a flow chart of a method of receiving data according to some embodiments. At 402, a block of samples is received. For example, an A/D converter 312 in the input module 310 may sample received data from the network at a fixed sample rate and convert the information into digital samples.

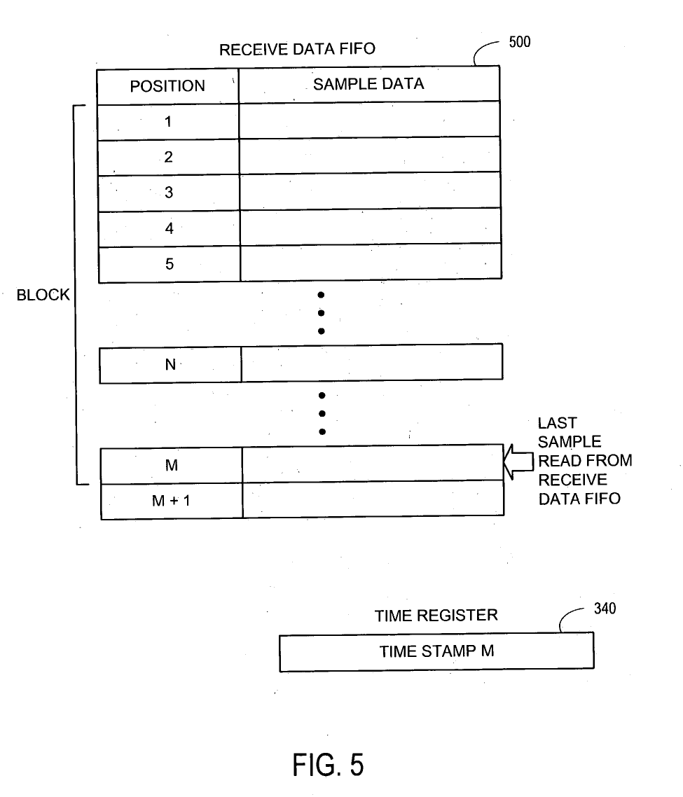

At 404, the samples are stored in a receive data First-In, First-Out (FIFO) 500. For example, an A/D interface 314 may take the digital samples from the A/D converter 312 and write them into the receive data FIFO 500. FIG. 5 illustrates the receive data FIFO 500 according to some embodiments.

At 406, time information is stored in a time register 340. For example, whenever the A/D interface 314 stores a sample in the receive data FIFO 500, an associated time stamp (e.g., generated by the timer 320) may be stored in a time stamp FIFO 330.

Moreover, each time a sample is read from the receive data FIFO 500 (e.g., to be processed by the DSP 100), the associated value in the time stamp FIFO 330 may be written into the time register 340 (overwriting any previous value that was stored in the time register 340). As a result, the time register 340 may always contain the time stamp associated with the last sample that was read from the receive data FIFO 500.

Processing Data

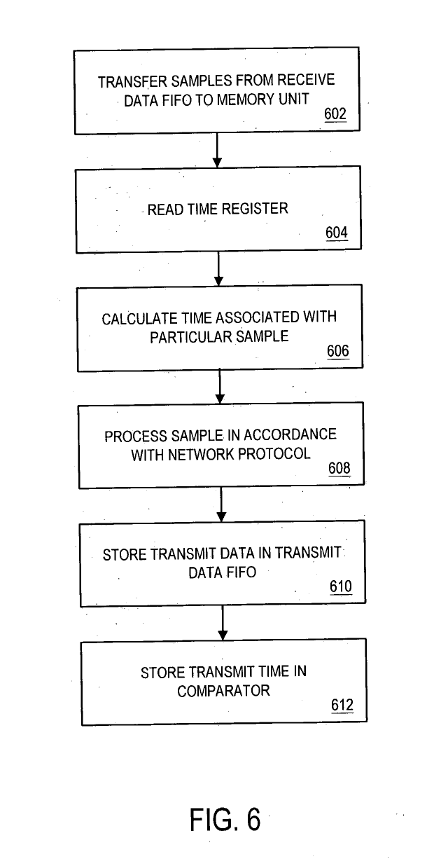

FIG. 6 is a flow chart of a method of processing data according to some embodiments. At 602, samples are transferred from the receive data FIFO 500 to the memory unit 110. For example, the DSP 100 may assign a DMA channel to transfer a block of samples from the receive data FIFO 500 to the memory unit 110. The DMA unit 120 would then read the samples from the receive data FIFO 500 and write the information into the memory unit 110.

At 604, information is read from the time register. For example, an interrupt may be sent to the DSP 100 when the DMA unit 120 finishes transferring a block of samples to the memory unit 110. In response to the interrupt, the DSP 100 may read the time stamp stored the time register 340 and re-program the DMA unit 120 to transfer the next block of samples.

At 606, a time associated with a particular sample is calculated. Note that, according to this embodiment, a single time stamp is associated with a block of samples. Because the sample rate is fixed, however, the DSP 100 may calculate an appropriate time stamp for every sample in the block.

Referring again to FIG. 5, recall that the value in the time register 340 is associated with the last sample that was transferred from the receive data FIFO 500 to the memory unit 110. For example, if a block of samples 1 through M was transferred to the memory unit 110, the value in the time register 340 would be associated with sample M. Thus, the appropriate time stamp for sample N would be:

tᵣ−(M−N)*tₛ

where tᵣ is the value currently stored in the time register 340 and tₛ is the sample interval time.

At 608, the sample is processed in accordance with a network protocol. For example, the DSP 100 may process the samples, extract events and timing information, and pass the information to a MAC. The events and timing information may then be used by the MAC to implement MAC layer protocol (e.g., re-transmission after collision or counting an inter-packet gap).

Thus, some embodiments may let the DSP 100 recover timing information associated with an event at the wire (i.e., at the PHY 300). Moreover, a single time stamp may be used to recover timing information for multiple samples. Such an approach may save memory space and reduce system costs (e.g., especially when the time stamps are larger than the samples).

At 610, transmit data is stored in a transmit data FIFO 360 in the output module 350. For example, the DSP 100 may prepare transmit data in the memory unit 110. The DMA unit 120 may then transfer the transmit data from the memory unit 110 to the transmit data FIFO 360.

At 612, a transmit time is stored in a comparator 370. For example, the DSP may determine a time at which transmit data should be transmitted to the network. An indication of this time may then be stored in the comparator 370.

Transmitting Data

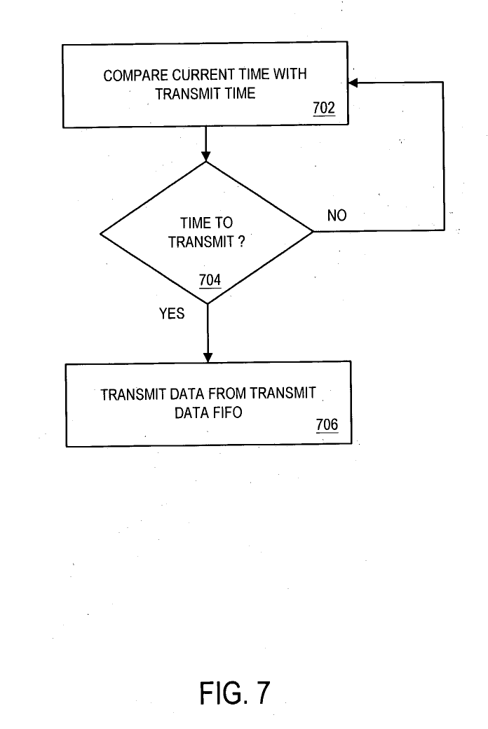

FIG. 7 is a flow chart of a method of transmitting data according to some embodiments. At 702, the current time is compared with the transmit time. For example, the comparator 370 may compare the current time generated by the timer 320 with the transmission time that was received from the DSP 100. If it is not yet time to transmit the data at 704, the process continues at 702.

When it is time to transmit the data, the data from the transmit data FIFO 360 is transmitted at 706. For example, a Digital-to-Analog (D/A) interface 354 may transfer digital information from the transmit data FIFO 360 to a D/A converter 352. The D/A converter 352 may then convert the digital information into analog information and transmit the analog information to the network.

As a result, the DSP 100 may schedule a transmission in accordance with the network protocol by controlling the value written into the comparator 370. If, for example, an Inter-Packet Gap (IPG) should be inserted between the end of packet reception and the beginning of packet transmission, the DSP 100 can calculate the transmission time by dividing the IPG time by the sample interval time and adding the result to the time stamp of the “end of receive” event.

System

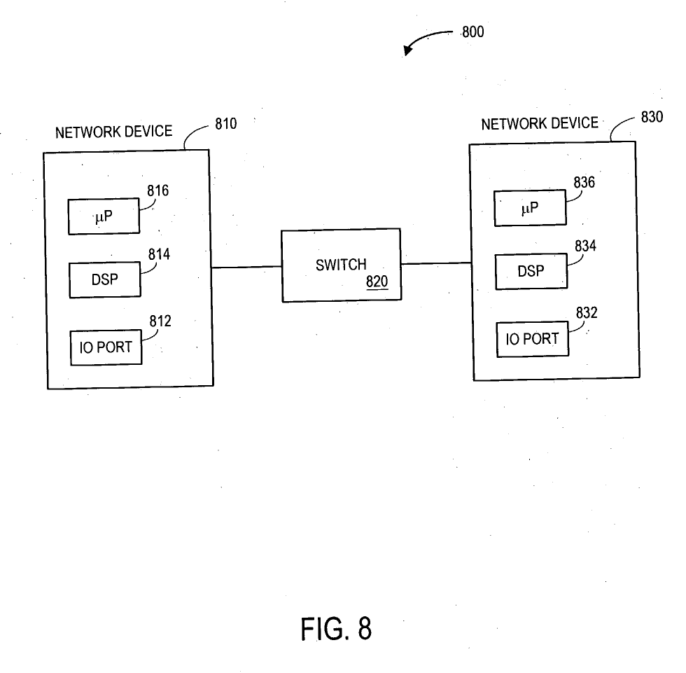

FIG. 8 is a system 800 according to some embodiments. In particular, a first network device 810 communicates with a second network device 830 via a switch 820. The first network device 810 includes an Input Output (IO) port 812, a DSP 814, and a microprocessor 816. The microprocessor 816 may, for example, execute an application that exchanges data via the IO port 812. Similarly, the second network device 830 includes an IO port 832, a DSP 834, and a microprocessor 836. Moreover, the first network device 810 and/or the second network device 830 may operate in accordance with any of the embodiments described herein. For example, the first network device 810 may associate time information with data received via the IO port 812. The DSP 814 may then process the received data in accordance with the time information.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described using a single time stamp for a block of samples, according to other embodiments the DSP 100 may receive a time stamp for each sample. For example, the receive data FIFO 500 may store both data and a corresponding time stamp for each sample.

Further, although software or hardware are described as performing certain functions herein, such functions may be performed using either software or hardware—or a combination of software and hardware.

The several embodiments described herein are solely for the purpose of illustration. Persons skilled in the art will recognize from this description other embodiments may be practiced with modifications and alterations limited only by the claims.

What is claimed is:

1. A method, comprising:
associating time information with data received at a physical layer processing unit; and
processing the received data via a digital signal processor in accordance with the time information.

2. The method of claim 1, further comprising:
storing the time information in a time register.

3. The method of claim 2, wherein the received data comprises a block of samples and the time information is associated with one of the samples.

4. The method of claim 3, further comprising:
determining a time associated with a particular sample based on the information in the time register and the position of the particular sample in the block.

5. The method of claim 4, wherein the time information in the time register is associated with the last sample in the block and said determining comprises:
calculating tᵣ−(M−N)*tₛ, where tᵣ is a time stored in the time register, M is the number of samples in the block, N is the location of the particular sample in the block, and tₛ is a sample interval time.

6. The method of claim 1, further comprising:
receiving the data via an analog-to-digital interface.

7. The method of claim 6, wherein the received data comprises a block of samples and further comprising:
storing the samples in a receive data memory structure.

8. The method of claim 7, further comprising:
storing in a time register a time stamp associated with one of the samples.

9. The method of claim 8, further comprising:
transferring the samples to a memory associated with the digital signal processor.

10. The method of claim 9, further comprising:
transferring transmit data to a transmit data memory structure; and
transmitting the transmit data via a digital-to-analog interface in accordance with a specified transmit time.

11. The method of claim 1, wherein said processing is associated with a network protocol.

12. The method of claim 11, wherein said processing is associated with at least one of: (i) a plurality of network protocols, (ii) a programmable network protocol, (iii) carrier sense processing, (iv) collision processing, and (v) transmission scheduling.

13. A medium storing instructions adapted to be executed by a processor to perform a method, said method comprising:
receiving a sample at a digital signal processor along with time information indicating when data was received at a physical layer processing unit; and
processing the sample in accordance with the time information.

14. The medium of claim 13, wherein said processing includes calculating a time associated with the sample based on the time information and the position of the sample in a block of samples.

15. A network device, comprising:
a timer;
a receive data memory structure to store a block of samples;
a time register to store a time indication generated by the timer, the time indication representing when a sample was received by a physical layer processing unit; and
a digital signal processor to process the block of samples in accordance with the time indication.

16. The network device of claim 15, further comprising:
an analog-to-digital interface to receive the samples.

17. The network device of claim 15, further comprising:
a direct memory access unit to transfer the samples from the receive data memory structure to a memory unit associated with the digital signal processor.

18. The network device of claim 15, further comprising:
a comparator to facilitate a transmission in accordance with information from the digital signal processor and the timer.

19. The network device of claim 18, further comprising:
a transmit data memory structure to store transmit data; and
a digital-to-analog interface to transmit the transmit data.

20. The network device of claim 15, wherein the network device is associated with at least one of: (i) a home network, (ii) a power line network, (iii) a phone line network, (iv) a network processor, and (v) a modem.

21. A system, comprising:
a main processor to execute an application that exchanges data via a network;
a timer;
a receive data memory structure to store a block of samples received via the network;
a time register to store a time indication generated by the timer, the time indication representing when a sample was received by a physical layer processing unit; and
a digital signal processor to process the block of samples in accordance with the time indication.

22. The system of claim 21, wherein the network is associated with at least one of: (i) a home network, (ii) a power line network, (iii) a phone line network, (iv) a network processor, and (v) a modem.
